(19) United States
(12) Patent Application Publication
(10) Pub. No.: US 2009/0305065 A1
(43) Pub. Date: Dec. 10, 2009

(54) Composition for coloring ceramic articles

(76) Inventor: Graziano Vignali, Sasso Marconi (IT)

Correspondence Address: ABELMAN, FRAYNE & SCHWAB, 666 THIRD AVENUE, 10TH FLOOR, NEW YORK, NY, 10017, US

(21) Appl. No.: 12/308,925

(22) PCT Filed: Jun. 25, 2007
(86) PCT No.: PCT/EP2007/056315

§ 371 Date: Dec. 23, 2008

(30) Foreign Application Priority Data
Jun. 26, 2006 (IT) MI2006A001228

(51) Int. Cl. C09D 11/02; C07F 7/00; B05D 5/00; B32B 9/04

(52) U.S. Cl. 428/454; 556/51; 427/287; 106/31.13

(57) ABSTRACT

The present invention relates to new liquid coloring compositions to be applied before firing to obtain, after firing, the white coloration of ceramic manufactured articles, or the decoloration of colored ceramic manufactured articles. The present invention also relates to new processes for coloring or decoloring using said liquid coloring compositions as well as to colored or decolored ceramic objects, obtainable with the new processes.

### FIELD OF THE INVENTION

The present invention relates to new liquid coloring compositions to be applied before firing to obtain, after firing, the white coloration of ceramic manufactured articles or the decoloration of colored ceramic manufactured articles. The present invention also relates to a new process for coloring or decoloring ceramic materials using said liquid coloring compositions as well as to colored or decolored ceramic objects obtainable with the new process.

### STATE OF THE ART

The use of colored ceramic products, as well as compositions and processes adopted to obtain the relevant colors, has been known for a long time. One of the most commonly used methods consists of the addition of powdered pigments, in particular inorganic oxides and mineral coloring matters to the ceramic body before firing. The ceramic manufactured article is thus colored through its whole thickness, although with large consumption of coloring matter, which is the most expensive component.

An alternative decoloration process consists of making the surface of the ceramic material absorb solutions of chromophoric metals which can turn into stable coloring products at high temperatures during the firing stage of the ceramic manufactured article. The coloring solutions are applied to the ceramic material by processes such as: dipping, spraying, disk spraying, silk-screen process, tampo printing, intaglio printing, ink-jet printing.

As regards spraying or disk spraying, there are two different applying methods: the first one comprises application by silk-screen printing of an impermeable layer which constitutes the negative of the drawing and subsequent spraying of the color which is absorbed only by non impermeabilized parts; the second one provides for the use of a particular decorating machine (Decospray) equipped with a circular screen that has a spraying nozzle inside. The color is sprayed through the openings of the screen, thus obtaining the desired drawing. This technique enables also to decorate non-planar surfaces, such as structured tiles. With the above mentioned techniques up to 800 g/m² of coloring solution can be deposited on the surface to be decorated.

The application by silk-screen or intaglio printing (Rotocolor® machine) enables to deposit the coloring solutions in specific positions, thus obtaining the desired drawing, in amounts from few cm³/m² to 400-500 cm³/m² in the case of silk-screen processes using screens 5 threads/cm, up to more than 600-700 cm³/m² using rollers equipped with appropriate “templates”, the amount of deposited coloring solution depending on the final product to be obtained. The application of coloring solutions to the ceramic material using these techniques is performed before the final firing. These coloring techniques are particularly preferred because they enable to obtain very thin colored layers and they are advantageously used in the case of planar objects (e.g., floor or wall tiles). They also enable to obtain graphics and drawings which otherwise cannot be obtained, and they consume smaller quantities of coloring matter. These techniques require the solutions to be thickened by means of appropriate organic or inorganic thickening agents.

Although it is well known that colouring solutions known in the art can advantageously be used both directly on the surface of ceramic manufactured articles, as for instance on unglazed vitrified stoneware tiles, or on the surface of a layer of enamel which may have been applied to the ceramic article, the penetration of the colouring solution in the ceramic material is particularly important in the case of unglazed vitrified stoneware tiles which undergo surface treatments after firing.

Starting from the late Eighties, porcelain stoneware has had increasing success. This product can be divided into two sub-classes:
product that does not undergo surface treatments after firing, known as “natural”, “rustic” or “raw”, which can be decorated with colouring solutions both directly on the surface or on an enamel layer eventually applied. From the economic viewpoint, products belonging to this class are the ones with the least value added;
product that undergoes surface treatments after firing, such as polishing, lapping, smoothing, etc. This product has higher value added and it can be decorated only with colouring solutions, because a more or less large part of surface material is removed, so the coloring matter must penetrate in depth. In the case of polishing, the thickness removed by means of special abrasive brushers may vary from few microns to 50-100 microns; the surface thus obtained gives a pleasant touch sensation and it is not shiny. In the case of lapping, the thickness removed by means of special grinding wheels and abrasive brushes may vary from 50 to 200 microns; the surface thus obtained has excellent feel to the touch and it may be opaque, matt, shiny and have roughness that reminds of certain natural stones. In the case of smoothing, the superficial part of the porcelain stoneware is abraded by means of diamond wheels; the thickness removed varies from 0.5 to 1.5 mm, in some cases exceeding 2 mm depending on the planarity of the tile. After smoothing, the stoneware is normally polished with suitable felts to obtain a mirror-shiny, or matt, planar surface. These surface treatments are carried out to obtain products that are similar to natural marbles and granites. The thickness of ceramic material removed in smoothing treatments depends upon the planarity of the tiles. Due to slight variations in the firing cycle or in the composition of the natural raw materials used in the ceramic mix, the tiles may be slightly concave or convex, and smoothing is the deeper the farther away the first orthogonal plane that comprises all the points of the surface of the tile is situated from the surface. It is therefore evident that, when having to decorate porcelain stoneware that will be smoothed after firing, it is necessary to obtain a penetration of the coloring compositions of at least 1.6 mm of depth, whereas if a smoothing exceeding 1.5 mm is necessary, the penetration should be at least 0.2 mm greater than the maximum thickness to be removed.

The penetration of colouring solutions into the ceramic material before firing can be facilitated by applying relatively high quantities of water on the manufactured article after the application of the coloring solution (post-treatment). This process entails obtaining less intense and homogeneous colors, for example the color sometimes concentrates in the deepest part of the tile. To overcome the problem of non homogeneous distribution, it is possible to use, as alternatives to water, particular products, called post-treatment products, such as solutions of mono- or polycarboxylic acids or alkali/alkali-earth metal derivatives thereof.

Penetration depth is also influenced by other parameters, such as:
pre-treatment with water or solutions of mono- or polycarboxylic acids or alkali/alkali-earth metal derivatives thereof;
viscosity and surface tension of the coloring solutions;
temperature of the surface whereon the application is carried out.

Depending on the final product to be obtained the person skilled in the art is able to select the suitable application technique and the operating parameters. For example, for silk-screen applications, once defined the type of silk screen to be used to deposit the necessary quantity of coloring solution it is possible to vary the pre-treatments and/or post-treatments depending on the final product to be realized. Normally, for equal amounts of chromophoric cation applied per unit surface area, the more thickness it is necessary to color, the more intensity the color loses.

Using coloring solutions currently available on the market, a rather broad range of colors can be obtained. It has long been known to those skilled in the art that coloring solutions comprising organic derivatives of cobalt, chromium, nickel, iron, vanadium can be used to obtain respectively the colors blue, from green to beige depending on concentration, turtledove-beige, warm beige, light beige on the finished product. To broaden the available chromatic range, the search for new colors by application of chromophoric metal solutions is however constantly ongoing. A first direction of research relates to the possible use of chromophoric metals other than those traditionally used for coloring ceramic materials: for instance, EP 704 411 describes the use of solutions comprising ruthenium organic salts to obtain the color black; DE 196 19 168 describes the use of palladium aqueous solutions to obtain a grey color; and EP1105358 describes gold compounds, compatible with the other colors, usable to change the chromatic signature of other colors.

In more recent times, the search for new colorations has been directed towards the study of combined use of solutions containing chromophoric ions and solid additives to be added to the ceramic body. By adding particular additives to the ceramic mixes it is possible to obtain new unforeseeable colorings, because the additive interacts with the chromophoric ions contained in the coloring solutions, modifying their chromatic yield. Thus, for example, international patent application WO9738952 describes a process for obtaining colorings from yellow to orange in which chrome solutions, containing another element selected among antimonium, zinc, zirconium and manganese, are applied on ceramic bodies added with TiO₂ to obtain colorings that range from yellow to orange.

It is well known in the art that these coloring solutions, recently placed on the market, irrespective of whether or not they need additives in the support, can also be used to decorate, before firing, surfaces of ceramic material covered by enamel suspensions (glazed ceramic materials).

Of particular importance is the color white, or the decoloring of colored ceramic material, because it enables to reproduce distinctive traits of natural stones, e.g. the white veins of natural marble. In this regard, many proposals are available on the market to those skilled in the art, and the prior art is also vast. Heretofore, however, every proposed solution nonetheless presents some technical problems, as highlighted below.

Coloring compositions based on zirconium oxychloride or on organic complexes of zirconium or tin or cerium or zinc, as described in the book “Colore pigmenti e colorazione in ceramica” [Pigment Color and Coloring in Ceramics], page 165, published by S.A.L.A. S.r.l, develop a considerable white coloring if they are used in quantities exceeding 400 g/m². However, these known coloring solutions present the problem of compromising the treated surface, making it rough, which sharply increases the vulnerability of the decorated ceramic product to being dirtied. Moreover, on ceramic substrates which undergo surface treatments after firing they develop cracks on the sides and within the decoration, or they increase the closed porosity within the decorated area, ruining the appearance and increasing vulnerability to dirtying.

Moreover, it is also known in the art that cerium nitrate solutions, if applied in quantities exceeding 200-300 g/m² can yield an acceptable white on smoothed surfaces, especially on green bodies colored with Thiviers Gres, appropriately decoloring them, but they still have the defect of forming micro-porosities in the decorating area that drastically increase the vulnerability of the manufactured article to dirtying.

Zinc based coloring solutions, as described in DE 19910484 by Heraeus GmbH, do not develop white colorings of sufficient interest and do not decolor ceramic supports colored with solid pigments.

Thus, it is readily apparent that the ceramic industry is strongly interested in finding new liquid coloring compositions able to be applied before firing that will yield, after firing, the white coloring of ceramic manufactured articles or the decoloring of colored ceramic manufactured articles, which do not give rise to the side problems described above. Therefore, a first object of the present invention is to provide such new liquid coloring compositions.

Technical Problem

Therefore, the technical problem underlying the instant invention is to find new coloring compositions to obtain white decorations on ceramic manufactured articles. More specifically, the problem is to provide new liquid coloring compositions usable before firing on glazed or unglazed ceramic manufactured articles, which are simultaneously able to:
give, after firing, the desired white coloring to said ceramic manufactured article, or decolor it if it is colored, e.g. with solid inorganic pigments.
obtain, in the case of surfaces that are not to undergo subsequent surface treatments, the desired decoration without an increase in the roughness/vulnerability to dirtying of the surface;
obtain the desired decoration within the ceramic manufactured article, for the depth needed to allow any subsequent surface treatment, without causing micro-holes (pores) or micro-cracks in the decorated surface.

### SUMMARY OF THE INVENTION

The applicant, who has full-fledged experience in the production and sale of coloring matters for ceramic tiles, has surprisingly found that the problem described above and additional further problems described below are solved by new liquid coloring compositions based on fluorometallates. In particular, the new liquid coloring compositions comprise salts and/or complexes formed by:
(a) one or more fluorometallate anions with the formula [MxFy]^{z-} where x, y and z are numeric coefficients and where x ranges from 1 to 7, y ranges from 2 to 31, and z ranges from 1 to 7, in which F is fluorine and M is selected from the group consisting of Zr, Ti, Sn, Al, and Sb,
(b) one or more cations independently selected from the group consisting of
   (b1) cations of metallic nature, whose corresponding oxides and silicates are white or colorless,
   (b2) cations having one nitrogen and the general formula:

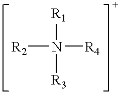

where
R1 is an organic radical, possibly substituted, or a hydroxyl, and
R2, R3 and R4 are, independently from each another, equal to H or to an organic radical, possibly substituted, and
(b3) ammonium.

The liquid colouring compositions of the invention can be applied before firing to obtain, after firing the white coloring of glazed or unglazed ceramic manufactured articles, or the decoloring of colored ceramic manufactured articles, either glazed or unglazed.

The applicant has also found a new process for white coloring or decoloring ceramic manufactured articles using said new liquid coloring compositions, and he has obtained, by using the new liquid coloring compositions, new decorated ceramic objects.

### DETAILED DESCRIPTION OF THE INVENTION

As stated above, the liquid coloring compositions found by the applicant can be used to color ceramic supports obtaining, after firing, at the surface and/or for the necessary depth, the development of the desired decoration, i.e. the white colorings on the ceramic supports to which no ceramic pigment has been added and decoloring of ceramic supports to which a pigment has been added. The term “decoration” as used in the present patent application indicates both the white coloring of a ceramic support to which no ceramic pigment has been added and the decoloring of a colored ceramic support, e.g a ceramic support to which a ceramic pigment has been added.

When the liquid coloring compositions of the invention are used, the obtained decoration is recognizable by increase in the L* value and said decoration is obtained without the development of superficial defects such as roughing, in particular without the formation of (micro)cracks and pores.

The liquid coloring compositions found by the applicant can be applied before firing to obtain, after firing, the decoration of ceramic articles both as they are, or glazed.

Among the fluorometallate anions with the formula [MxFy]^{z-} present as component (a) in the salts and/or complexes comprised in the liquid coloring compositions of the present invention, the fluorometallates in which M is Zr are preferred. Among the fluorometallate anions with the formula [MxFy]^{z-} used in the liquid coloring compositions of the present invention the fluorometallates in which x ranges from 1 to 7, y ranges from 2 to 31 and z ranges from 1 to 7 are preferred.

Among the fluorometallate anions in which M is Zr, particularly preferred are those in which the Zr:F ratio ranges from 1:4 to 1:12, the ratios 1:6 and 1:8 being particularly preferred. The most preferred anions are hexafluorozirconates.

Among cations of metallic nature, present as component (b1) in the salts and/or complexes used in the liquid coloring compositions of the present invention, cations selected from the group consisting of Al, Sb, Ce, Sn, Zn, Ca, Li, Na, K, Mg, Sr, Ba, Hf, Sc, Y, Lu, Ga, As, Se and Te are preferred. Among the latter, particularly preferred are the cations selected from the group consisting of Na, K, Li, Al, Sb, Ce, Sn and Zn, and among them, in turn more preferred are Sn and Zn.

The liquid coloring compositions of the invention comprising a fluorozirconate ion [ZrxFy]^{z-} and one or more cation of metallic nature (b1), preferably comprise at least one compound selected among:

potassium zinc hexafluorozirconate [K₂Zn(ZrF₆)₂] (CAS 68168-04-7);

zinc hexafluorozirconate pentahydrate [Zn(ZrF₆)5H₂O] (CAS 851222-11-2);

tetrasodium octafluorozirconate [Na₄(ZrF₈)] (CAS 205315-52-2);

barium tetrafluorozirconate [Ba(ZrF₄)] (CAS 133752-06-4);

magnesium hexafluorozirconate [Mg(ZrF₆)] (CAS 30868-50-9);

magnesium hexafluorozirconate hexaydrate [Mg(ZrF₆)6H₂O] (CAS 65532-17-4);

zinc octafluorozirconate dodecahydrate [Zn₂(ZrF₈)12H₂O] (CAS 22925-88-8);

barium sodium heptafluorozirconate [BaNa(ZrF₇)] (CAS 146277-62-5);

barium di-μ-fluorodecafluorodizirconate [Ba₂(Zr₂F₁₂)] (CAS 66683-82-7);

zinc hexafluorozirconate hexaydrate [Zn(ZrF₆)6H₂O] (CAS 22925-87-7);

zinc hexafluorozirconate [Zn(ZrF₆)] (CAS 30868-56-5);

barium decafluorozirconate [Ba₃(ZrF₁₀)] (CAS 73740-62-2);

pentasodium μ-fluorododecafluorodizirconate [Na₅(Zr₂F₁₃)] (CAS 12022-20-7);

barium hexafluorozirconate [Ba(ZrF₆)] (CAS 56082-13-4);

sodium zirconium fluoride dodecahydrate [Na₇Zr₆F₃₁] (CAS 433231-09-5);

barium di-μ-fluorooctafluorodizirconate [BaZr₂F₁₀] (CAS 73756-22-6);

barium sodium zirconium fluoride [BaNaZr₂F₁₁] (CAS 107375-54-2);

potassium stannum zirconium fluoride [KSnZrF₇] (CAS 847659-14-7);

yttrium zirconium fluoride [YZrF₇] (CAS 12763-85-8);

yttrium zirconium fluoride [YZr₃F₁₅] (CAS 74505-00-3);

barium tetradecafluorotrizirconate [BaZr₃F₁₄] (CAS 107958-87-2);

barium zirconium fluoride dihydrate [BaZr₂F₁₀] (CAS 142194-92-1);

sodium pentafluorozirconate [NaZrF₅] (CAS 13871-10-8);

cerium zirconium fluoride [CeZr₂F₁₁] (CAS 144134-78-1);

lutetium zirconium fluoride [LuZr₃F₁₅] (CAS 74505-03-6);

barium hexadecafluorotrizirconate [Ba₂Zr₃F₁₆] (CAS 107958-88-3);

barium di-μ-fluorododecafluorodizirconate [Ba₃Zr₂F₁₄] (CAS 126368-64-7);

trisodium undecafluorodizirconate [Na₃Zr₂F₁₁] (CAS 12140-29-3);

disodium hexafluorozirconate [Na₂ZrF₆] (CAS 16925-26-1);

potassium sodium hexafluorozirconate [KNaZrF6)] (CAS 65366-76-9);

aluminium hexafluorozirconate [Al₂(ZrF₆)₃] (CAS 134609-96-4);

trisodium heptafluorozirconate [Na₃ZrF₇] (CAS 17442-98-7);

zinc hexaaquohexafluorozirconate [Zn₆ZrF₆x6H₂O] (CAS 58340-99-1);

potassium sodium pentafluorozirconate [K₃Na₂(ZrF₅)₅] CAS 65366-85-0);

potassium zinc hexafluorozirconate hexaydrate [(K₂ZnZrF₆)6H₂O] (CAS 67871-25-4);

sodium zinc zirconium fluoride [NaZnZr₂F₁₁] (CAS 172374-73-1);

zinc zirconium fluoride heptahydrate [(ZnZr₂F₁₀)7H₂O] (CAS 851207-84-6);

cerium potassium zirconium fluoride [CeKZr₂F₁₂] (CAS 214199-78-7);

barium lithium zirconium fluoride [BaLiZr₂F₁₁] (CAS 127737-62-6);

trisodium nonadecafluorotetrazirconate [Na₃Zr₄F₁₉] (CAS 12140-35-1);

barium octafluorozirconate [Ba₂Zr₈] (CAS 76122-12-8);

zinc zirconium fluoride hydrate [(ZnZr₂F₁₀)H₂O] (CAS 851207-85-7);

lutetium potassium zirconium fluoride [LuKZr₂F₁₂] (CAS 214200-23-4);

barium hafnium sodium zirconium fluoride [BaHfNaZrF₁₁] (CAS 140882-95-7);

lutetium zirconium fluoride [LuZrF₇] (CAS 12763-76-7);

sodium pentafluorozirconate monohydrate [(NaZrF₅)H₂O] (CAS 20982-58-5);

sodium zirconium fluoride [Na₇Zr₆F₃₁] (CAS 12140-37-3);

lithium sodium zirconium fluoride [LiNaZr₄F₁₈] (CAS 12140-33-9);

potassium sodium heptafluorozirconate [K₃Na₃(ZrF₇)₂] (CAS 65391-31-3);

dilithium hexafluorozirconate [Li₂ZrF₆] (CAS 17275-59-1);

stannum zirconium fluoride (or di-stannum zirconium octafluoride) [Sn₂ZrF₈] (CAS 11095-62-8);

stannous hexafluorozirconate [SnZrF₆] (CAS 12419-43-1) and

stannum dodecafluorozirconate [Sn₄ZrF₁₂].

The above-mentioned compounds can be obtained by processes known to those skilled in the art, normally by reacting a source of cation (b1), preferably an oxide, a mixed oxide or a halogen derivative of the cation, with a source of zirconium, preferably hexafluorozirconic acid, zirconium fluoride, zirconium oxide or oxychloride, zirconium carbonate or basic zirconium carbonate, eventually in the presence of fluoridric acid, in aqueous solution. For example, SnZrF₆ can be obtain by reacting hexafluorozirconic acid and SnO as disclosed in GB 1,174,079 or alternatively by reacting different sources of Sn(II) with zirconium derivatives as described in U.S. Pat. No. 3,337,295 possibly in the presence of HF. The above-mentioned compounds can also be easily obtained by processes not carried out in aqueous solutions, as for instance processes in the molten state, said processes being less preferred.

Among the cations present as component (b2) are preferred the cations in which at least one among R1, R2, R3 and R4 is
(i) a linear or branched aliphatic radical C₁-C₁₂ possibly provided with
   (ia) substituents located on the terminal or intermediate groups of the chain, selected from the group consisting of oxydryl, aminic, iminic, amidic, carboxylic groups or organic radicals R5 possibly substituted,
   and/or provided with
   (ib) bivalent groups —NR6-, —O— or —CONH— inserted in the aliphatic chain,
   and/or provided with
   (ic) 1-4 double and/or triple bonds in the chain, or
(ii) a cycloaliphatic or aromatic radical C₄-C₆ possibly provided with
   (iia) substituents located on the groups of the aliphatic or aromatic cycle, selected from the group consisting of oxydryl, aminic, amidic, carboxylic groups or organic radicals R5 possibly substituted,
   and/or provided with
   (iib) bivalent groups —NR6-, —O— or —CONH— inserted in the aliphatic cycle,
   and/or provided with
   (iic) 1-2 double bonds, or
(iii) R1 and R2 together are a bivalent radical C₄-C₆ constituting an aliphatic or aromatic cycle comprising nitrogen, possibly provided with
   (iiia) substituents located on the groups of the aliphatic or aromatic cycle, selected from the group consisting of oxydryl, aminic, amidic, carboxylic groups or organic radicals R5 possibly substituted,
   and/or provided with
   (iiib) bivalent groups —NR6-, —O— inserted in the aliphatic or aromatic cycle,
   and/or provided with
   (iiic) 1-2 double bonds,

wherein R6 is an organic radical or is H.

Among the linear organic radicals of the (ia/b) type, interleaved with bivalent radicals of the —NH— type, and also provided with aminic substituents, particularly preferred are the following:

—CH2CH2NHCH2CH2NH2;

—CH2CH2NHCH2CH2NHCH2CH2NH2;

—CH2CH2NHCH2CH2NHCH2CH2NHCH2CH2NH2;

—CH2CH2CH2NHCH2CH2NHCH2CH2CH2NH2.

Also preferred are liquid coloring compositions according to the present invention in which the (b2) is a group consisting of:

hydroxylammonium, methylammonium, ethylammonium, propylammonium, dimethylammonium, diethylammonium, dipropylammonium, trimethylammonium, triethylammonium, tripropylammonium, 2-ethanolammonium (2-hydroxyethanammonium), diethanolammonium, triethanolammonium, isopropylammonium, diisopropylammonium, triisopropylammonium, n-butylammonium, isobutylammonium, sec-butylammonium, tert-butylammonium, cyclohexylammonium, benzylammonium, alfa-phenylethylammonium, beta-phenylethylammonium, diphenylammonium, triphenylammonium, phenylammonium, dibenzylammonium, aminoethylenammonium, aminopropylenammonium, aminohexamethylenammonium, piperazonium, methylpiperazonium, ethylpiperazonium, 2-aminoethylpiperazonium, morpholinonium, pyridinium, bis-2-aminoethylammonium, bis-2-aminopropylammonium, propanolammonium, di-propanolammonium, tris-propanolammonium, hydroxyl-ethyl-piperazonium, hydroxyl-propyl-piperazonium, di-butylammonium, di-cyclohexylammonium, N,N′-dimethylpiperazonium, N-methylmorpholinonium, piperidonium, N-methylpiperidonium, N,N′-di-(2-hydroxyethyl)piperazonium, N-methyl hydroxyethylpiperazonium, N,N′-di(2-hydroxypropyl)piperazonium, N-methyl-2-hydroxypropylpiperazonium, N,N′-1,2-ethandiilbis[N-(carboxymethyl)]-glycinonium (derived from EDTA), N,N-bis[2-[bis(carboxymethyl)amino]ethyl]-glycinonium (derived from DTPA), N,N-bis(carboxymethyl)-glycinonium (derived from NTA), N-(carboxymethyl)-glycinonium (derived from NDA), N-[2-[bis(carboxymethyl)amino]ethyl]-N-(2-hydroxyethyl)-glycinonium (derived from HEDTA), α,α′-(1,2-ethandiildiimino)bis[2-hydroxy]benzenacetic-onium acid (derived from EDDHA), α,α′-(1,2-ethandiildiimino)bis[2-hydroxy]-4-methylbenzenacetic-onium acid and α,α′-(1,2-ethandiildiimino)bis[2-hydroxy]-5-methylbenzenacetic-onium acid (derived, respectively, from two EDDHMA isomers).

Also usable are the cations (b2) deriving from aminoacids, preferably deriving from arginine, aspartic acid, glutamic acid, glycine, leucine, lysine, proline and tyrosine. As stated above, the salts and/or complexes formed by the fluorometallate anions and by the cations according to the present invention can comprise not just solely cations (b1) or (b2) or (b3), but also the mixed compositions (b1)(b2), (b1)(b3), (b2)(b3), (b1)(b2)(b3). For example, ammonium stannum hexafluorozirconate [NH₄SnZrF₆] (CAS 847659-13-6) or potassium ammonium hexafluorozirconate.

Ammonium cations of (b2)-type wherein R1 is a linear or branched alkyl radical and at least one of the groups R2, R3 or R4 is H are preferred. The liquid coloring compositions of the invention comprising salts and/or complexes formed by at least one fluorometallate (a) and said preferred ammonium cations of (b2)-type can be prepared by reacting the fluorometallic acid, particularly preferably hexafluorozirconic acid, with an amine selected from the group consisting of primary, secondary, tertiary amines and mixtures thereof in whatever acid/amine molar ratio and in the presence of a liquid, if any. According to a particularly preferred embodiment, the acid/amine molar ratio ranges from 1:2 to 3:2.

It has been surprisingly found that liquid coloring compositions comprising organic compounds formed by an anion [ZrF₆]²⁻ and an ethanolammonium cation, wherein the anion/cation molar ratio ranges from 1:1 to 1:2 are particularly preferred because they bring about a remarkable increase in the L* value of the decorated ceramic support. Said compounds can be prepared by reacting hexafluorozirconic acid, preferably in the form of an aqueous solution thereof, with 2-ethanolammine with a molar ratio [ZrF₆]²⁻/ethanolamine ranging from 1:1 to 1:2.

The liquid coloring compositions according to the present invention can be prepared with various liquids, used in the technical field, provided they solubilise at least partially the salts and/or complexes. Thus, the liquid coloring composition of the instant invention are preferably formulated as inks, i.e. as compositions in which the salts and/or complexes are totally solubilised in the solvent used, or less preferably as suspensions, i.e. as compositions in which the salts and/or complexes are partly dissolved in the solvent used and partly in suspended solid form.

According to the first and preferred embodiment, the liquid colouring compositions are inks in which the salts and/or complexes are totally solubilised and in which (b) is one or more cations independently selected among (b1) and (b2). When inks are prepared, it is critical for the liquid used to be able to fully solubilise the salts and/or complexes according to the present invention, i.e. it is critical for the liquid used to constitute a solvent for them. In particular, the inks according to the invention can be prepared with polar or non-polar solvents, either miscible or immiscible with water, the choice of the appropriate solvent depending on the solubility of the salts and/or complexes comprised in the inks of the invention. Therefore, the inks of the present invention, may comprise water-soluble salts and/or complexes as described above and a solvent selected among water, water-miscible solvents and mixtures thereof. Suitable water-miscible solvents are, for example, alcohols or glycols. Alternatively, the inks of the invention, may comprise water-insoluble salts and/or complexes as described above and a water immiscible-solvent or a mixture of different water-immiscible solvents. In this latter embodiment, water-miscible solvents may optionally be added. Water-miscible solvents, in particular selected among water itself, alcohols, glycols, or mixtures thereof, are however preferred, because they are less hazardous, both from the toxicological and environmental viewpoint, than water immiscible organic solvents, such as aliphatic hydrocarbons up to b.p. 300° C., aromatic solvents, naphthas, etc., which are preferably used for ink-jet inks. For ink-jet printing, inks having conductivity of al least 3 μS/cm, normally in the range of 150-16000 μS/cm, are preferred. Instead, the use of aqueous or hydroalcoholic inks minimizes the polluting emissions developed during the step of firing the decorated ceramic material.

From the toxicological viewpoint, particularly preferred are the inks according to the present invention comprising less than 1 wt % of HF. However, any presence of HF can be eliminated by degassing as well as by adding basic zirconium carbonate according to the quantity of HF.

Preferred inks according to the invention comprise fluorozirconates as fluorometallate anion and have a zirconium content, expressed as elementary zirconium, from 0.265 to 27.8 wt %, preferably from 1.3 to 25.5 wt %, more preferably from 6.0 to 20.0 wt %, particularly preferably from 8.0 to 18.0 wt %.

The inks according to the present invention are preferred over the suspensions because the use of inks results in eliminated application problems, e.g. the clogging of the silk screens or rollers and in the possibility of using advanced application techniques, such as ink jet printing.

According to a less preferred embodiment, the inks of the present invention can also comprise, in addition to the salts or complexes of the present invention, modest quantities of known white dies, e.g. further organic complexes of zirconium or tin or cerium or zinc, when, because of the low quantity added, no precipitation is formed in the inks thus modified and when said modified inks still solve the technical problem identified above.

In an embodiment that is alternative to and less preferred than the inks, it is possible to formulate the liquid coloring compositions of the present invention in coloring suspension, in which the salts and/or complexes are present partly dissolved in the liquid used and partly in suspended solid form. Within the present invention, the term “coloring suspensions” refers to suspensions in which at least 20 wt %, preferably at least 33 wt % of the total amount of salts and/or complexes is dissolved, whilst the rest is suspended.

Preferably, the coloring suspension of the instant invention comprise salts and/or complexes formed exclusively by one or more fluorometallate anion (a) as described above and cations (b3), i.e. ammonium, and the liquid used to obtain the suspension is selected from the group consisting of water, water-miscible liquids and mixtures thereof. Using the coloring suspensions as defined in the present invention, it becomes possible to execute in-depth colorings (thus comparable to those obtainable with the inks), pre- and/or post-treating, before and/or after the application of the coloring suspension on the ceramic manufactured article to solubilise and then drive in depth, at the time of and/or after deposition on the tile, at least a part of the solids of the suspension. As pre- or post-treatment agent, the same liquid used for the preparation of the suspension, or another solvent, can be used.

Moreover, the suspensions of the present invention show unexpected improvements over known aqueous suspension of white ceramic pigments, namely that of penetrating into the ceramic manufactured articles thus being usable not only for surface applications but also for applications in which the surface will be worked (ex. abraded or partially ablated) subsequently.

It is clear that the liquid coloring compositions of the present invention, whether they be inks or suspensions, in addition to the components listed above can also comprise effective amounts of:
known thickening agents, be them organic like e.g. modified glucomannans, starches and modified starch derivatives, cellulose and modified cellulose derivatives or inorganic like e.g. clays, bentons, silicates, modified silica derivatives etc; and/or
additional co-operating substances that modify or stabilize some physical characteristics such as ionic force, viscosity, surface tension, the visibility of the application, or others, to optimise the applicability of the coloring compositions according to the present invention.

The process for decorating ceramic articles with the liquid coloring compositions according to the present invention entails the application before firing of said liquid coloring compositions on a raw or partially fired ceramic article. With the process of the invention it is possible both to white-color ceramic articles and to decolor colored ceramic articles. The liquid coloring compositions according to the invention can also be used for the decoration of so-called “malmiscelato” ceramic body. The term “malmiscelato” (poorly mixed) indicates ceramic articles constituted by multiple mixtures having different composition, said mixtures being not completely mixed.

In particular, said processes comprise the following operative steps:
a) preparing a raw or partially fired ceramic article to be decorated,
   a1) optional pre-treatment,
b) treating the ceramic article with the liquid coloring composition according to the present invention on the surface of said ceramic articles,
   b1) optional post-treatment,
   b2) optional drying and/or balancing
c) firing the ceramic article obtained according to the previous steps at a temperature of least at 940° C., preferably using the same firing parameters usable for firing the same untreated ceramic article and a firing temperature which ranges from +20° to −20° C. with respect to the firing temperature usable for firing the same untreated ceramic article.

The process according to the invention can be carried out on either glazed or unglazed ceramic articles; the process in which said ceramic articles are unglazed ceramic tiles being preferred. Non limiting examples of some preferred types of ceramic articles that can be decorated with the liquid coloring compositions according to the invention are green bodies obtained by pressing raw atomized ceramic mixes for porcelain stoneware, supports obtained by extrusion, biscuited supports, etc.

Especially on unglazed ceramic surfaces, the penetration depth of the liquid coloring compositions is influenced by the quantity of the liquid coloring compositions applied as well as by the pre- and/or post-treatment steps optionally carried out. The possibility of modulating penetration depth not only by means of the applied quantities but also by means of the pre- and/or post treatments, allows savings in liquid coloring composition.

Inks generally require less pronounced pre- and/or post-treatments than suspensions. Said treatments can be carried out with water or with aqueous solutions of mono- or poly-carboxylic acids. Preferably, said mono- or poly-carboxylic acids contain 1 to 10 carbon atoms, with possibly from 1 to 5 oxydryl, aminic or thiolic substituents in the aliphatic chain, said mono- or poly-carboxylic acids being possibly partially or completely salified with ammonium, amines, alkaline metals and/or alkaline-earth metals. Normally, up to 300 g/m² of pre-treating or post-treating solution, or both, are applied. Preferably, the treatments in question are carried out by spraying or disc-spraying applications. Post-treating solutions can also, or exclusively, contain halogenates, e.g. sodium chloride.

With regard to the techniques for treating the ceramic articles with the liquid coloring compositions according to the present invention, conventional techniques as well as—in the case of the inks—advanced techniques can be used. In the case of liquid coloring compositions formulated as inks, preferred techniques for treating the glazed or unglazed ceramic articles, be them raw or partially fired, are silk screen printing, spraying or disk-spaying, silicon-rollers printing, tampo or intaglio printing, ink-jet printing, ink-jet printing being particularly preferred.

With regard instead to the techniques for applying the coloring suspensions according to the present invention, they can equally be applied on the raw or partially fired ceramic articles, glazed or not, with the conventional techniques, except ink-jet printing. Some of these techniques, to the extent to which they are susceptible to the formation of solid residues deriving from suspensions, require, however, very frequent cleaning of the application devices used, and therefore they are less preferred than less susceptible techniques. The process for decorating ceramic articles according to the present invention are advantageous if the obtainable product is a porcelain stoneware tile. The process according to the invention is particularly advantageous if said tiles have to undergo superficial treatments after firing such as polishing, lapping, smoothing and/or brushing.

In this latter case, the person skilled in the art is able to define the most suitable application technique to be used according to the final product to be obtained and to optimize the necessary pre- and/or post-treatments. For example, using the inks of the present invention, if a satin finished product is to be obtained, the skilled person can employ silk-screens from 36 to 61 threads/cm or intaglio printing rollers XD or 03 (Rotocolor® system). If a smoothed product is to be obtained, the skill person can use silk screens 10 or 21 threads/cm, or intaglio printing rollers 05 or “templates”.

When the step (b) of the process of the invention is carried out by means of spraying or disk-spraying, silk-screen printing, tampo- or intaglio-printing or silicon-roller printing the amount of liquid coloring composition applied for surface area secures the application of at least 8 g/m², preferably 8-130 g/m², more preferably 10-100 g/m², of Zr (expressed as elementary zirconium).

Of interest are the processes according to the invention in which the step (b) is carried out using an ink-jet printing device that exploit the four-color printing concept using, instead of the black dye, a white dye. In conventional four-color printing, black dye is used to make the colorings obtainable with three-color printing (red-yellow-blue) darker, whereas in the four-color printing system using white dyes, white can be used to make a coloring obtainable in three-color printing lighter and more brilliant thus exalting its perception. Alternatively, a white dye can be used together with the 4 basic colors (cyan-magenta-yellow-black) to obtain five-color printing.

According to a peculiar embodiment, the step (b) of the process of the invention can be carried out in two steps by firstly uniformly treating, e.g. by spraying, the ceramic manufactured article with the liquid colouring composition of the invention, preferably with liquid coloring compositions comprising [ZrF₆]²⁻ as fluorometallate ion, and subsequently by applying known coloring solutions, preferably inks, e.g. commercial inks normally used for ink-jet printing, on the treated surface using one or more appropriate devices, preferably ink-jet devices.

The firing temperature of the ceramic article in the processes of the invention varies according to the ceramic body used and to the type of product to be obtained. By way of non limiting example, it should be reported that to obtain porcelain stoneware manufactured articles firing usually occurs around 1200-1220° C., for monoporosa around 1060-1100° C., for single firing on glazed substrates around 1150-1160° C. For double firing products, the first firing is normally carried out at 1030-1080° C. and the second firing at temperatures slightly lower than the first one.

The processes according to the present invention comprise a step of firing the ceramic manufactured article that is marginally modified, preferably unchanged, with respect to the standard firing cycle usable for firing the same manufactured article not decorated according to the invention, namely the firing temperature in the process of the invention ranges from +20° to −20° C. with respect to the firing temperature usable for firing the same untreated ceramic article. The person skilled in the art, when implementing the invention, is able to choose on the base of the type of ceramic manufactured article the suitable operating parameters for firing, such as kiln temperature and firing time. For example, the liquid coloring compositions according to the invention can be conveniently used on partially fired supports, provided they can still absorb liquids; in this case, for color development the decorated manufactured article will have to be fired again at a temperature exceeding 940° C.

Carrying out the process of the invention in which the new liquid coloring compositions are used, new glazed or unglazed ceramic articles are obtainable, the surface of said ceramic articles being totally or partially decorated, i.e. totally or partially white colored or decolored. In particular, new ceramic articles made of porcelain stoneware are obtainable, the surface of said articles being totally or partially decorated and totally or partially abraded after firing, for example by brushing, polishing, lapping and/or smoothing.

The color variations developed with the liquid coloring compositions according to the present invention can be measured using the CIELab system. In the colorimetric space L*a*b*, L* indicates luminosity and varies between 0 and 100 (where 0 represents black and 100 white). In the present case, the invention is characterized by an increase in L*, hence by a positive ΔL*, hence by an increase in the degree of white or in luminosity.

ΔL*=L*(sample)−L*(std).

where L*(std) is the L* value of the un-treated (un-colored or un-decolored) ceramic article.

Experimental Part

All the examples that follow, when not expressly indicated, were realized using green tiles for porcelain stoneware. The firing step was carried out in an industrial kiln having a suitable firing cycle for the ceramic body used. Some specimens were smoothed after the firing step with diamond wheel down to a depth of about 0.6 mm.

Color measurements were performed according to the L*a*b* system, using a colorimeter Dr. Lange Model Spectrapen (LZM224—Standard No. 1009).

Used Compositions:
A. (Comparative.) Aqueous commercial solution containing 45% of hexafluorozirconic acid (CAS 12021-95-3) containing at most 2% of HF.
B. (Invention.) Aqueous solution of stannous hexafluorozirconate. Zr and Sn concentrations 13.26 wt % and 17.26 wt % respectively, expressed as elementary metals. The solution were obtained by adding to 66.67 g of the solution A (0.1455 moles) 19.6 g of SnO (0.1455 moles) and agitating for 60 minutes, otherwise until complete dissolution. The solution was then diluted to 100 g with water.
C. (Invention) Solution of 2-hydroxy ethanammonium hexafluorozirconate, Zr concentration 15.3 wt %, obtained by adding to 76.92 g of the solution A (0.168 moles) 22.8 g of a 90% water solution of 2-ethanolamine (0.336 moles) and agitating for 60 minutes, or otherwise until complete dissolution. The solution is then diluted to 100 g with water. The 2-hydroxy ethanammonium hexafluorozirconate is a viscous liquid product with Zr=27.8 wt %. Diluting with water, all concentrations below 27.8% can be obtained. The product as such presents high absorption times. They become acceptable diluting it with water until having a concentration of Zr=19.1 wt %.
   C1. (Invention.) Solution C concentrated until having Zr=19.1%.
   C2. (Invention.) Solution C concentrated until having Zr=25.5%.
D. (Invention.) Solution of zinc hexafluorozirconate, Zr=13.2 wt % Zn=9.5 wt % expressed as elementary metals. The solution was obtained adding to 100 g of solution A 17.9 g of zinc oxide at 99% and agitating 60 minutes, otherwise until complete dissolution. The solution is then diluted to 150 g with water.
E. (Comparative.) Solution of zirconium ammonium glycolate containing 14.8 wt % of Zr expressed as elementary metal. 50 g of basic zirconium carbonate (40% ZrO₂) were added at 75° to 52.9 g of glycolic acid at 70% in water. The mixture was then heated to 70-80° for 6/8 hours. After cooling, an aqueous solution of ammonia at 30% was added to neutralize to pH=7; the solution was then diluted with water to 100 g.
F. (Comparative.) Solution of zirconium oxychloride containing 18 wt % of Zr expressed as elementary metal.
G. (Comparative.) Solution of zinc acetate containing 8 wt % of Zn expressed as elementary metal in accordance with DE 19910484.
H. (Comparative) Solution of zinc ammonium ethylenediaminetetraacetic acid (EDTA) containing 10 wt % of Zn expressed as elementary metal in accordance with DE 19910484, stabilized with ammonia.
I. (Invention.) Suspension based on a saturated aqueous solution of ammonium hexafluorozirconate, containing about 15 wt % of solubilised ammonium hexafluorozirconate, equal to about 5.67 wt % of zirconium in water-soluble form and 21 wt % of solid ammonium hexafluorozirconate for a total content of about 14 wt % of Zr.
J. (Comparative.) Aqueous solution of cerium nitrate at 24.3 wt % of cerium.

Used Ceramic Bodies

The tests were performed on green bodies obtained by pressing ceramic bodies having the following average composition:
CI W03, marketed by Cooperativa Ceramica d'Imola: SiO₂ 67-68%; Al₂O₃ 16.8-17.4%; Fe₂O₃ 0.3-0.4%; TiO₂ 0.3-0.4%; Na₂O 4.5-5%; K₂O 1.1-1.6%; MgO 0.15-0.2%; CaO 0.5-0.6%; ZrO₂ 4.5-5.2%; L.O.I. 2.5-3.5%;
CI White, marketed by Cooperativa Imola: SiO₂ 71-72%; Al₂O₃ 15.2-16.2%; Fe₂O₃ 0.4-0.5%; TiO₂ 0.35-0.45%; Na₂O 3.5-4.5%; K₂O 1.6-2.4%; MgO 0.1-0.15%; CaO 0.68-0.76%; ZrO₂ 1.5-2%; L.O.I. 2.5-3.5%;
Meta verde [Meta green] Code 9250 atomized for fine green porcelain stoneware marketed by Meta SpA: SiO2 66.5-67.5%; Al₂O₃ 20.3-21.3%; Fe₂O₃ 0.4-0.5%; TiO₂ 0.1-0.2%; CaO 1-1.5%; MgO 0.3-0.8%; K₂0 1.2-1.8%; Na₂O 4.5-5.5%; chrome pigment 0.5-0.8%; L.O.I 3-4%;
Meta beige Code 9380 atomized for fine beige porcelain stoneware marketed by Meta SpA: SiO_{2 66.5}-67.5%; Al₂O₃ 20.3-21.3%; Fe₂O₃ 0.4-0.5%; TiO₂ 0.1-0.2%; CaO 1-1.5%; MgO 0.3-0.8%; K₂0 1.2-1.8%; Na₂O 4.5-5.5%; pink pigment 0.2-0-4%; yellow pigment 0.1-0.2%; L.O.I. 3-4%;
Meta nero [Meta black] Cod. 9230 atomized for fine black porcelain stoneware marketed by Meta SpA: SiO₂ 66.5-67.5%; Al₂O₃ 20.3-21.3%; Fe₂O₃ 0.4-0.5%; TiO₂ 0.1-0.2%; CaO 1-1.5%; MgO 0.3-0.8%; K₂O 1.2-1.8%; Na₂O 4.5-5.5%; black pigment 1.2-2.2%; L.O.I. 3-4%.
Meta SUPERWHITE Cod. 9150, atomized for fine porcelain stoneware marketed by Meta SpA: SiO₂ 67-72%; Al₂O₃ 16-20%; Fe₂O₃ 0.2-0.7%; TiO₂ 0.3-0.6%; CaO; 0.3-0.6%; MgO; 0.2-0.4%; K₂O; 1-2%; Na₂O; 4-5%; Zr(SiO₄)3-5%; C; traces; S; traces.

L.O.I.=Loss on ignition—considered to be humidity and organic matter.

In the examples that follow, the tiles obtained from the ceramic bodies marketed by Meta SpA were fired with 55-minute “Meta” firing cycle (cold-cold) at a maximum temperature of 1,215° C. and smoothed, when provided. The tiles obtained from the green bodies marketed by Cooperativa Ceramica d'Imola were fired with 50-minute “CI” firing cycle (cold-cold) at a maximum temperature of 1,215° C. and smoothed, when provided.

Smoothing depth in the following examples was 0.6 mm, unless otherwise indicated.

### Example 1

Drop Tests of Compositions According to the Invention and of Comparative Compositions on “White” and Colored Mixes.

Some of the compositions described above from A to J were diluted with water, before the application. In these cases, the ratio coloring composition/water is reported on following Tables 1 and 2.

The coloring compositions were applied on the surface of the green bodies depositing two drops thereof (equal to 400-500 g/m²) by means of drop bottle.

The L*(sample) of all smoothed tests was recorded. Table 1 shows the ΔL* values. L*(std) values of the smoothed supports as such (untreated) were:

| | L* |
|---|---|
| META GREEN | 49.87 |
| META BEIGE | 70.01 |
| CI WHITE | 76.30 |
| CI W03 | 83.08 |
| META BLACK | 31.35 |

The acronym Bno in the table below indicates non uniform white, no recording was made.

TABLE 1

| | Meta | | | | Meta |
|---|---|---|---|---|---|
| Composition | green | Meta beige | CI white | CI WO3 | black |
| code | ΔL* | | | | |
| B. | 7.968 | 3.629 | 3.761 | 2.43 | 8.932 |
| B 50/H2O | 2.316 | −0.631 | 1.98 | 1.683 | 1.642 |
| 50 | | | | | |
| B 40/H2O | 2.97 | 0.912 | 1.308 | 1.271 | 1.572 |
| 60 | | | | | |
| E | Bno | Bno | 4.787 | 2.768 | 1.96 |
| E 50/H2O | 0.946 | 0.566 | 0.938 | 0.913 | 1.265 |
| 50 | | | | | |
| E 40/H2O | 1.074 | 0.448 | 0.729 | 0.694 | 1.111 |
| 60 | | | | | |
| J | 1.421 | −0.085 | 0.348 | −0.63 | 3.171 |
| J 50/H2O 50 | −1.812 | −1.474 | −0.36 | −0.24 | −0.948 |
| J 40/H2O 60 | −1.333 | −1.452 | −0.379 | −0.304 | −0.803 |
| F | 6.863 | 3.232 | 4.5 | 3.791 | 1.745 |
| F 50/H2O | 4.944 | 1.764 | 2.959 | 2.662 | 1.831 |
| 50 | | | | | |
| F 40/H2O | 4.663 | 2.62 | 2.873 | 2.045 | 0.754 |
| 60 | | | | | |
| D | 9.021 | 3.336 | 2.382 | 2.015 | 11.656 |
| D 50/H2O | 0.192 | −1.076 | 1.118 | 0.991 | 0.618 |
| 50 | | | | | |
| D 40/H2O | 0 | −1.343 | 0.867 | 0.83 | −0.635 |
| 60 | | | | | |
| G | −0.325 | −1.401 | −1.57 | −0.82 | −0.14 |
| G 50/H2O 50 | −0.458 | −1.003 | −0.87 | −0.64 | 1.484 |
| G 40/H2O | −0.325 | −0.874 | −0.74 | −0.44 | −0.117 |
| 60 | | | | | |
| H | 3.666 | 2.334 | 0.897 | −0.608 | 15.311 |
| H 50/H2O | 0.012 | −0.709 | −0.096 | −0.716 | 7.911 |
| 50 | | | | | |
| H 40/H2O | −0.084 | | −0.416 | −0.448 | 1.572 |
| 60 | | | | | |
| A | 3.537 | 0.545 | 4.964 | 0.311 | 2.468 |
| A 50/H2O | −0.156 | −1.22 | 1.32 | 1.498 | 1.441 |
| 50 | | | | | |
| A 40/H2O | −0.568 | −1.191 | 0.879 | 0.684 | 0.277 |
| 60 | | | | | |
| I | 1.329 | 0.35 | 1.728 | 0.28 | 2.067 |
| I 50/H2O 50 | −0.998 | 0.524 | 1.71 | 0.752 | 2.194 |
| I 40/H2O 60 | −1.035 | −0.134 | 1.657 | 0.788 | 0.185 |

To highlight the properties of the liquid coloring compositions according to the invention, in addition to the results of Table 1, the conditions and the appearance of the surface treated with the drops, both smoothed and un-smoothed, were assessed. A check was made to detect the presence of holes or micro-cracks on the decorated portion. Tiles were assessed only if ΔL*>1. Scores assigned according to the scoring system below are collected in Table 2.

Smoothed tiles: Scoring system:

0=ΔL*<1
1=decorated surface not acceptable, presence of micro-cracks or micro holes that would make the manufactured article not sellable;
2=decorated surface identical to the untreated surface.

Unsmoothed tiles: Scoring system:
0=decorated surface ruined, product unusable because vulnerability to dirtying increases drastically;
1=rough or slightly bulged decorated surface;
2=decorated surface identical to the untreated surface.

TABLE 2

| | conditions and appearance of the surface - drop tests | | | | | | | | | |
|---|---|---|---|---|---|---|---|---|---|---|
| | Smoothed | | | | | Rough article | | | | |
| | manufactured article | | | | | (not smoothed) | | | | Sum |
| Composition | Meta | Meta | CI | | Meta | Meta | Meta | CI | Meta | of |
| code | green | beige | white | CI WO3 | black | green | beige | white | black | scores |
| B | 1 | 2 | 2 | 2 | 1 | 1 | 1 | 1 | 1 | 44 |
| B 50/H2O 50 | 2 | 0 | 2 | 2 | 2 | 2 | 2 | 2 | 2 | |
| B 40/H2O 60 | 2 | 0 | 2 | 2 | 2 | 2 | 2 | 2 | 2 | |
| E | 1 | 0 | 1 | 1 | 1 | 1 | 0 | 2 | 1 | 24 |
| E 50/H2O 50 | 1 | 0 | 0 | 0 | 1 | 1 | 2 | 2 | 1 | |
| E 40/H2O 60 | 1 | 0 | 0 | 0 | 1 | 1 | 2 | 2 | 1 | |
| J | 2 | 0 | 0 | 0 | 2 | 1 | 1 | 2 | 2 | 18 |
| J 50/H2O 50 | 0 | 0 | 0 | 0 | 0 | 1 | 1 | 1 | 1 | |
| J 40/H2O 60 | 0 | 0 | 0 | 0 | 0 | 1 | 1 | 1 | 1 | |
| F | 1 | 1 | 1 | 1 | 1 | 0 | 0 | 0 | 0 | 16 |
| F 50/H2O 50 | 1 | 1 | 1 | 2 | 1 | 0 | 0 | 0 | 0 | |
| F 40/H2O 60 | 1 | 1 | 1 | 2 | 0 | 0 | 0 | 0 | 0 | |
| D | 1 | 2 | 2 | 2 | 1 | 1 | 2 | 2 | 1 | 32 |
| D 50/H2O 50 | 2 | 0 | 2 | 0 | 0 | 2 | 2 | 1 | 1 | |
| D 40/H2O 60 | 2 | 0 | 0 | 0 | 0 | 2 | 2 | 1 | 1 | |
| G | 0 | 0 | 0 | 0 | 0 | 1 | 0 | 1 | 1 | 11 |
| G 50/H2O 50 | 0 | 0 | 0 | 0 | 2 | 1 | 0 | 1 | 1 | |
| G 40/H2O 60 | 0 | 0 | 0 | 0 | 0 | 1 | 0 | 1 | 1 | |
| H | 2 | 2 | 0 | 0 | 1 | 1 | 0 | 1 | 1 | 18 |
| H 50/H2O 50 | 0 | 0 | 0 | 0 | 2 | 1 | 0 | 1 | 1 | |
| H 40/H2O 60 | 0 | 0 | 0 | 0 | 1 | 1 | 1 | 1 | 1 | |
| A | 1 | 0 | 1 | 0 | 1 | 0 | 0 | 0 | 1 | 17 |
| A 50/H2O 50 | 0 | 0 | 1 | 2 | 2 | 1 | 1 | 0 | 1 | |
| A 40/H2O 60 | 0 | 0 | 0 | 0 | 0 | 1 | 2 | 0 | 2 | |
| I | 1 | 0 | 2 | 0 | 2 | 2 | 1 | 2 | 1 | 31 |
| I 50/H2O 50 | 0 | 0 | 2 | 0 | 1 | 2 | 2 | 2 | 2 | |
| I 40/H2O 60 | 0 | 0 | 1 | 0 | 0 | 2 | 2 | 2 | 2 | |

As is readily apparent, the derivatives of hexafluorozirconic acid, B, D, I, yielded the best results. It should be noted that I, although it is a suspension, yields equivalent results to those obtainable with inks. Whilst composition I is equally effective, it is nonetheless less preferred because, being a suspension, it presents the problems described above and highlighted in the application tests that follow.

### Example 2

Application Comparison between Compositions B (Ink) and I (Coloring Suspension) According to the Present Invention.

The most commonly used application technique at this time is the technique with intaglio printing roller. This technique consists of etching very small holes on a silicone roller. The silicone roller rotates about its axis and, thanks to the very slight lateral thrust action of a blade (doctor blade) on which color is continuously loaded, the holes are filled with color. The roller, continuing its revolution, comes in contact with the tile that is transported on a conveyor at the same speed as the roller; the holes filled with color in contact with the tile are emptied, depositing the color with extreme precision. In view of the principles of the technique, the importance of the constancy of the deposited weight is readily understandable. If the deposited weight decreases over time, there are the so-called “tones” which reduce the value of production, if not the complete absence of decoration, especially when decorating tiles that require a removal of the superficial layer (smoothed).

To verify the application performance, two liquid coloring compositions were applied with an intaglio printing roller, etching GS 42 14°, S5 System, on cold tiles. The roller had a surface area of 20×25 cm, 100% etching. The speed of the belt was 20 m/min., pressure of the doctor 3.2. 100 tiles, 40×40 cm, were decorated, 2.5 minutes of application. The tile no. 1 and no. 100 were weighed before and after application and the weight difference, representing the quantity of color deposited, is reported on Table 3.

Solution B applied after thickening had a viscosity, measured with Ford cup hole 4, of 18″.

Suspension I was used as such due to its high viscosity (not measurable with Ford Cup hole 4).

TABLE 3

| Composition | | |
|---|---|---|
| code | Weight dep. on 1^{st} tile | Weight dep. on 100^{th} tile |
| B | 3.3 g | 3.3 g |
| I | 2.9 g | 2.4 g |

The suspension I presented problems of a drop in deposited weight. The drop in deposited weight can be attributed to the progressive clogging of the hole because of the solid part of the suspension. In addition to the defect of progressively reducing the deposit, which entails frequently stopping production to dismantle and clean the roller, the suspension I also presents the problem of the abrasive action of the solid part of the suspension on the roller when it passes under the doctor blade, which drastically reduces the working life of the roller itself.

### Example 3

Silk Screen Tests of Compositions According to the Invention and of Comparative Compositions on Uncolored Ceramic Bodies.

All silk screen tests, using 10 and 21 threads/cm screens, were conducted on green bodies obtained by pressing the ceramic body Meta SUPERWHITE. All liquid coloring compositions were thickened with thickener known in the art as described above. The post treatment used (PST) was an aqueous solution of anhydrous trisodic salt of 2-hydroxy-1,2,3-propanetricarboxylic acid at 3.5 wt %. Two post treatment quantities were tested, 200 and 300 g/m². The decorated tiles, after post treatment and drying in stove at 60° C. for 30 minutes, were fired with “Meta” firing cycle.

Of all tests, smoothed and rough, the value of L*(sample) was recorded. On Table 4 the following data are collected:
ΔL*: When there was no color variation or L*(sample) could not be measured because the surface was too compromised, or because of a considerable surface residue, a ΔL* of 0 was considered. The value of L*(std) of the non decorated area was 76.8.
Cracks/Holes: The presence of cracks or holes within the decorated area and the presence of cracks on the edge of the decoration was checked and assessed according to the following ranking system:
   NO=no damage
   YES=presence of holes or cracks.
Overall evaluation: Figure representing the sum of the scores assigned to the tests. Scoring system:
   ΔL*<0.5: no score—the assessment is carried out only if ΔL* was at least 0.5. It was decided to lower the criteria with respect to the drop tests of Example 1 because the quantity of material deposited by silk screen printing is far smaller, 400 cm³/m² for drops, 250 cm³/m² for screens 10 threads/cm, 120 cm³/m² for screens 21 threads/cm;
   NO=2 YES=−2

TABLE 4

| | | Smoothed | | | | Rough article | | | | |
|---|---|---|---|---|---|---|---|---|---|---|
| | | manufactured article | | | | not smoothed | | | | |
| | | PST 200 | | PST 300 | | PST 200 | | PST 300 | | Results |
| Composition | No. | g/m2 | | g/m2 | | g/m2 | | g/m2 | | of |
| Used: | wires/cm | 10 | 21 | 10 | 21 | 10 | 21 | 10 | 21 | assessment |
| B | ΔL* | 0.8 | 0.6 | 1.6 | 0.5 | 5.3 | 3.4 | 5.2 | 2.4 | 32 |
| | Internal | NO | NO | NO | NO | NO | NO | NO | NO | |
| | cracks or | | | | | | | | | |
| | holes | | | | | | | | | |
| | Cracks | NO | NO | NO | NO | NO | NO | NO | NO | |
| | on edge | | | | | | | | | |
| D | ΔL* | 0.8 | 0 | 0.9 | 2.6 | 2.9 | 3.5 | 2.5 | 0 | 24 |
| | Internal | NO | NO | NO | NO | NO | NO | NO | NO | |
| | cracks or | | | | | | | | | |
| | holes | | | | | | | | | |
| | Cracks | NO | NO | NO | NO | NO | NO | NO | NO | |
| | on edge | | | | | | | | | |
| C | ΔL* | 3 | 0.4 | 3.7 | 0.5 | 1.9 | 0.7 | 1.9 | 0.7 | 28 |
| | Internal | NO | NO | NO | NO | NO | NO | NO | NO | |
| | cracks or | | | | | | | | | |
| | holes | | | | | | | | | |
| | Cracks | NO | NO | NO | NO | NO | NO | NO | NO | |
| | on edge | | | | | | | | | |
| F | ΔL* | 0 | 0 | 0 | 0 | 0 | 2.8 | 0 | 3.2 | 8 |
| | Internal | YES | NO | YES | NO | YES | NO | YES | NO | |
| | cracks or | | | | | | | | | |
| | holes | | | | | | | | | |
| | Cracks | YES | NO | YES | NO | NO | NO | NO | NO | |
| | on edge | | | | | | | | | |

As it is readily apparent, the coloring compositions comprising fluorozirconates (B, D, C) yield the best results.

### Example 4

Drop Tests of Compositions According to the Invention on Smoothed Manufactured Articles

As described above, the derivatives of hexafluorozirconic acid can yield inks with high Zr concentrations, useful to obtain high ΔL* on the smoothed articles; some examples are provided in Table 5.

The inks were applied on the green ceramic body surface depositing two drops thereof (equal to 400-500 g/m²) by means of drop bottle. The tiles were obtained starting from the CI White ceramic body and fired with “CI” firing cycle.

All tests were smoothed 0.6-0.7 mm. Table 5 shows the ΔL* value.

TABLE 5

| | L* | ΔL* |
|---|---|---|
| Non decorated support | 76.4 | |
| Sol. B | 79.4 | 3 |
| Sol. C | 78.5 | 2.1 |
| Sol. C2 | 86.2 | 9.8 |
| Sol. C1 | 79.4 | 3 |

### Example 5

Drop Tests of Compositions According to the Invention on Rough Manufactured Article.

The derivatives of hexafluorozirconic acid, when used to decorate manufactured articles that do not have to undergo surface removals, can also be used in extremely diluted solutions as demonstrated by the tests that follow.

Solution B, diluted before the application to progressively lower concentrations, is drop-tested (2 drops) on differently colored supports.

Table 6 shows the ΔL* value. L*(std) values of the smoothed supports as such (untreated) were:

| | L* (std) |
|---|---|
| META GREEN | 50.7 |
| META BEIGE | 69.2 |
| CI W03 | 82.6 |
| META BLACK | 36.0 |

TABLE 6

| g of composition | | | Meta | Meta | Meta | |
|---|---|---|---|---|---|---|
| B diluted to 100 g | | | black | green | beige | CI WO3 |
| with water | wt % Zr | wt % Sn | ΔL* | | | |
| 8 | 1.06 | 1.381 | 4 | 4.6 | 3.1 | 0.6 |
| 6 | 0.769 | 1.036 | 3.4 | 4.4 | 3.3 | 0.5 |
| 4 | 0.58 | 0.69 | 3.7 | 5.1 | 2.9 | 0.4 |
| 2 | 0.265 | 0.345 | 2.6 | 5 | 1.7 | not visible |

### Example 6

Tests of Compositions According to the Invention Sprayed as Base for Subsequent Ink-Jet Application of other Colors.

The compositions of the instant invention, in particular compositions comprising specific derivatives of the hexafluorozirconic acid can be used to increase the brilliancy of the colors used for ink jet.

The following Table 7 shows the values of L* of ink-jet inks deposited by ink-jet on raw ceramic support, untreated and treated by spraying with 50 g/m² of composition B.

The ceramic support used is obtained by pressing the COEM STANDARD mix. The firing cycle is 59 minutes (cold-cold) at a maximum temperature of 1,215° C.

TABLE 7

| | |
|---|---|
| untreated support | Treated support |

Ink jet ink

| | L* | L* |
|---|---|---|
| | 85.4 | 86.9 |
| Magenta Ink IJP- | 73.1 | 75.3 |
| M28 | | |
| Yellow Ink IPJ-Y28 | 79.1 | 82.6 |
| Cyan Ink IPJ-C28 | 71.6 | 75.3 |
| Black Ink IPJ-K28 | 64.9 | 69.1 |

As shown by the data above, L* of ink-jet colors on the treated support increases by more than 1 with respect to the untreated support.

### Example 7

Tests of Compositions According to the Invention, Applied in Drops on Glazed Supports.

The solution D, appropriately diluted, was applied on an ceramic double-firing support glazed with FCE 671 frit, marketed by Ferro Italia S.r.l. The enamel was prepared mixing 800 grams of FCE 671 frit with 400 g of water; the thus obtained composition was applied by spraying on the biscuited support in the measure of 1200 g/m². The substrate was subsequently dried in a stove at 120° C. until constant weight. The liquid coloring composition D was applied on the ceramic surface depositing two drops thereof with drop bottle, equal to 400-500 g/m². Subsequently, the decorated manufactured article was dried in a stove at 120° C. until weight was constant and fired with a 60-minute firing cycle (cold-cold) at a maximum temperature of 1120° C. The value of L*(std) of the non decorated glazed support was 86.0.

TABLE 8

| Solution used | L* (sample) | ΔL* |
|---|---|---|
| Sol D 10/H2O 90 | 88.3 | 2.3 |

### Example 8

Compositions According to the Invention with Fluorozirconates having Zr/F Ratio other than 1:6.

Fluorozirconates with Zr/F ratio different from 1:6 were prepared.

Composition K—based on Sn₂ZrF₈: obtained by adding to 10.4 g SnF₂ Aldrich 6.4 g of ZrF₄ hydrate Aldrich (Zr=47.7%) and 9 g demineralised water. The composition was heated by water bath at 40° C. After 60 minutes, solubilisation is nearly complete.

Composition L—based on Sn₄ZrF₁₂ obtained by adding to 10.4 g SnF₂ Aldrich 3.2 g of ZrF₄ hydrate Aldrich (Zr=47.7 wt %) and 5 g of demineralised water. The composition was heated by water bath at 40° C. for 60 minutes, then 5 more grams of demineralised water were added and the agitation was continued at 40° C. for further 60 minutes. The solutions K and L thus obtained, as they were and diluted, were subsequently drop tested, with the same procedures described above, on raw ceramic tiles obtained with the CI WHITE atomized ceramic body.

TABLE 9

| L* of the undecorated | | L* of the undecorated | |
|---|---|---|---|
| support 76.0 | | support 75.7 | |
| g of K brought | | g of L brought | |
| to 100 g with water | L* measured | to 100 g with water | L* measured |
| 100 | 82.2 | 100 | 79.3 |
| 50 | 78 | 50 | 77.3 |
| 20 | 77.5 | 20 | 76.7 |

### Example 9

Further Compositions According to the Invention

The compositions of the examples were prepared as follows and applied onto unfired ceramic tiles as disclosed in Example 1. Tests specimens of unfired ceramic tiles were obtained by pressing the spray-dried powder of “CI WO3” and “META NERO” having the same oxide composition of the ceramic bodies described above.

(9.1) Methylamine
0.109 moles of H₂ZrF₆ (50 g of a 45.2 wt % aqueous solution) were made to react with 0.218 moles of methylamine (16.9 g of a 40 wt % aqueous solution). Zr concentration in tested composition 14.8 wt %.

(9.2) Diethylamine
0.109 moles of H₂ZrF₆ (50 g of a 45.2 wt % aqueous solution) were made to react with 0.218 moles of liquid diethylamine (15.95 g). Zr concentration in tested composition 15.1 wt %.

(9.3) Isopropylamine
0.109 moles of H₂ZrF₆ (50 g of a 45.2 wt % aqueous solution) were made to react with 0.218 moles of liquid isopropylamine (12.85 g) in the presence of 8.9 g of water. Zr concentration in tested composition 13.8 wt %.

(9.4) Morpholine
0.109 moles of H₂ZrF₆ (50 g of a 45.2 wt % aqueous solution) were made to react with 0.218 moles of liquid morpholine (19.0 g) in the presence of 15.2 g of water. Zr concentration in tested composition 11.8 wt %.

(9.5) Triethanolamine
0.109 moles of H₂ZrF₆ (50 g of a 45.2 wt % aqueous solution) were made to react with 0.218 moles of triethanolamine (38.3 g of a 85 wt % aqueous solution). Zr concentration in tested composition 11.2 wt %.

(9.6) Glycine
0.109 moles of H₂ZrF₆ (50 g of a 45.2 wt % aqueous solution) were made to react with 0.218 moles of solid glycine (16.36 g) in the presence of 18.64 g of water. Zr concentration in tested composition 11.7 wt %.

(9.7) Hydroxylamine
0.109 moles of H₂ZrF₆ (50 g of a 45.2 wt % aqueous solution) were made to react with 0.218 moles of hydroxylamine (14.4 g of a 50 wt % aqueous solution). Zr concentration in tested composition 15.4 wt %.

(9.8) Aminoethylpiperazine
0.109 moles of H₂ZrF₆ (50 g of a 45.2 wt % aqueous solution) were made to react with 0.073 moles of liquid aminoethylpiperazine (9.4 g). Zr concentration in tested composition 16.7 wt %.

(9.9) Aminoethylpiperazine (1/1)
0.109 moles of H₂ZrF₆ (50 g of a 45.2 wt % aqueous solution) were made to react with 0.109 moles of liquid aminoethylpiperazine (14.1 g). Zr concentration in tested composition 15.5 wt %.

(9.10) Ethanolamine
0.109 moles of H₂ZrF₆ (50 g of a 45.2 wt % aqueous solution) were made to react with 0.109 moles of liquid 2-ethanolamine (7.4 g of a 90 wt % aqueous solution). Zr concentration in tested composition 17.3 wt %.

(9.11) Ethan/Methyl
0.109 moles of H₂ZrF₆ (50 g of a 45.2 wt % aqueous solution) were made to react with 0.109 moles of liquid 2-ethanolamine (7.4 g of a 90 wt % aqueous solution) and 0.109 moles of liquid methylamine (8.45 g of a 40 wt % aqueous solution). Zr concentration in tested composition 15.1 wt %.

(9.12) Hexanediamine
0.109 moles of H₂ZrF₆ (50 g of a 45.2 wt % aqueous solution) were made to react with 0.109 moles of solid 1,6-hexanediamine (12.7 g). Zr concentration in tested composition 15.8 wt %.

(9.13) Ethan/Stan
0.109 moles of H₂ZrF₆ (50 g of a 45.2 wt % aqueous solution) were made to react with 0.109 moles of liquid ethanolamine (7.4 g of a 90 wt % aqueous solution) and 0.0545 moles of solid stannous oxide (7.34 g). Zr concentration in tested composition 15.4 wt %.

(9.14) Aniline
0.109 moles of H₂ZrF₆ (50 g of a 45.2 wt % aqueous solution) were made to react with 0.218 moles of liquid aniline (20.3 g) in the presence of 50.0 g of water. A solid sediment was present in the resulting composition. Only the supernatant liquid was used in the coloring test.

(9.15) Benzylamine
0.109 moles of H₂ZrF₆ (50 g of a 45.2 wt % aqueous solution) were made to react with 0.218 moles of liquid benzylamine (23.36 g) in the presence of 50.0 g of water. A solid sediment was present in the resulting composition. Only the supernatant liquid was used in the coloring test.

The test specimens were fired according to the appropriate ceramic firing cycles and subsequently smoothed.

The ΔL* values recorded on rough (unsmoothed) tiles are collected on Table 10. The reference L*(std) values of the ceramic tiles as such (not treated with the compositions of the invention) were:
83.741 for “CI WO3” and 36.818 for “META NERO” for tests (9.1) to (9.11) and
83.104 for “CI WO3” and 37.515 for “META NERO” for tests (9.12) to (9.15).

TABLE 10

| | | C.I. WO3 | META NERO |
|---|---|---|---|
| (9.1) | Methylamine | 1.13 | 3.15 |
| | Methylamine 50/H₂O 50 | 1.27 | 2.37 |
| | Methylamine 40/H₂O 60 | 1.32 | 1.61 |
| (9.2) | Diethylamine | 4.02 | 10.91 |
| | Diethylamine 50/H₂O 50 | 2.33 | 5.30 |
| | Diethylamine 40/H₂O 60 | 1.77 | 5.81 |
| (9.3) | Isopropylamine | 4.65 | 9.44 |
| | Isopropylamine 50/H₂O 50 | 3.04 | 7.52 |
| | Isopropylamine 40/H₂O 60 | 1.95 | 6.27 |
| (9.4) | Morpholine | 1.17 | 4.78 |
| | Morpholine 50/H₂O 50 | 1.16 | 2.34 |
| | Morpholine 40/H₂O 60 | 1.14 | 2.54 |
| (9.5) | Triethanolamine | 1.66 | / |
| | Triethanolamine 50/H₂O 50 | 0.83 | 4.81 |
| | Triethanolamine 40/H₂O 60 | −0.17 | 4.89 |
| (9.6) | Glycine | 2.86 | 4.84 |
| | Glycine 50/H₂O 50 | 1.60 | 2.63 |
| | Glycine 40/H₂O 60 | 1.51 | 2.51 |
| (9.7) | Hydroxylamine | 3.98 | 10.55 |
| | Hydroxylamine 50/H₂O 50 | 2.09 | 6.08 |
| | Hydroxylamine 40/H₂O 60 | 1.97 | 5.67 |
| (9.8) | Aminoethylpiperazine | 3.19 | 9.71 |
| | Aminoethylpiperazine 50/H₂O 50 | 1.81 | 4.37 |
| | Aminoethylpiperazine 40/H₂O 60 | 1.37 | 3.64 |
| (9.9) | Aminoethylpiperazine (1/1) | 4.69 | 11.52 |
| | Aminoethylpiperazine 50/H₂O 50 | 1.43 | 2.36 |
| | Aminoethylpiperazine 40/H₂O 60 | 0.70 | 2.41 |
| (9.10) | Ethanolamine | 6.54 | 15.46 |
| | Ethanolamine 50/H₂O 50 | 4.01 | 7.10 |
| | Ethanolamine 40/H₂O 60 | 3.68 | 7.11 |
| (9.11) | Ethan/Methyl | 0.89 | 3.21 |
| | Ethan/Methyl 50/H₂O 50 | 1.40 | 2.74 |
| | Ethan/Methyl 40/H₂O 60 | 1.14 | 1.87 |
| (9.12) | Hexanediamine | / | / |
| | Hexanediamine 50/H₂O 50 | 1.29 | 7.27 |
| | Hexanediamine 40/H₂O 60 | 1.49 | 5.28 |
| (9.13) | Ethan/Stan | 6.20 | 23.34 |
| | Ethan/Stan 50/H₂O 50 | 1.60 | 5.17 |
| | Ethan/Stan 40/H₂O 60 | 1.15 | 1.36 |
| (9.14) | Aniline | 3.02 | 8.70 |
| | Aniline 50/H₂O 50 | 1.98 | 1.38 |
| | Aniline 40/H₂O 60 | 1.77 | 1.67 |
| (9.15) | Benzylamine | 2.91 | 11.27 |
| | Benzylamine 50/H₂O 50 | 1.86 | 5.52 |
| | Benzylamine 40/H₂O 60 | 1.90 | 4.47 |

1-22. (canceled)

23. Organic compound formed by an anion [ZrF₆]²⁻ and a 2-ethanolammonium cation, wherein the anion/cation molar ratio ranges from 1:1 to 1:2.

24. Process for the decoration of ceramic articles at a firing temperature of at least 940° C. comprising the use of a liquid coloring composition, the liquid coloring composition comprising salts and/or complexes formed by:
(a) one or more fluorometallate anions with the formula [MxFy]^{z-} where x, y and z are numeric coefficients and where x ranges from 1 to 7, y ranges from 2 to 31, and z ranges from 1 to 7, in which F is fluorine and in which M is selected from the group consisting of Zr, Ti, Sn and Al,
(b) one or more cations independently selected from the group consisting of
(b1) cations of metallic nature, whose corresponding oxides and silicates are white or colorless,
(b2) cations having the general formula: 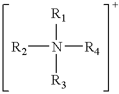
where
R1 is an organic radical, a substituted organic radical, or a hydroxyl, and
R2, R3 and R4 are, independently from each other, equal to H, an organic radical, or a substituted organic radical, and
(b3) ammonium.

25. Process according to claim 24, wherein M is Zr.

26. Process according to claim 25, wherein the Zr:F ratio ranges from 1:4 to 1:12.

27. Process according to claim 24, wherein the cation (b1) is selected from the group consisting of Al, Sb, Ce, Sn, Zn, Ca, Li, Na, K, Mg, Sr, Ba, Hf, Sc, Y, Lu, Ga, As, Se and Te.

28. Process according to claim 24, wherein the liquid coloring composition comprises at least one compound selected from the group consisting of K₂Zn(ZrF₆)₂, Zn(ZrF₆)5H₂O, Na₄(ZrF₈), Ba(ZrF₄), Mg(ZrF₆), Mg(ZrF₆)6H₂O, Zn₂(ZrF₈)12H₂O, BaNa(ZrF₇), Ba₂(Zr₂F₁₂), Zn(ZrF₆)6H₂O, Zn(ZrF₆), Ba₃(ZrF₁₀), Na₅(Zr₂F₁₃), Ba(ZrF₆), Na₇Zr₆F₃₁, BaZr₂F₁₀, BaNaZr₂F₁₁, KSnZrF₇, YZrF₇, YZr₃F₁₅, BaZr₃F₁₄, BaZr₂F₁₀, NaZrF₅, CeZr₂F₁₁, LuZr₃F₁₅, Ba₂Zr₃F₁₆, Ba₃Zr₂F₁₁, Na₂ZrF₆, KNaZrF₆, Al₂(ZrF₆)₃, Na₃ZrF₇, Zn₆ZrF₆x6H₂O, K₃Na₂(ZrF₅)₅, (K₂ZnZrF₆)6H₂O, NaZnZr₂F₁₁, (ZnZr₂F₁₀)7H₂O, CeKZr₂F₁₂, BaLiZr₂F₁₁, Na₃Zr₄F₁₉, Ba₂Zr₈, (ZnZr₂F₁₀)H₂O, LuKZr₂F₁₂, BaHfNaZrF₁₁, LuZrF₇, (NaZrF₅)H₂O, Na₇Zr₆F₃₁, LiNaZr₄F₁₈, K₃Na₃(ZrF₇)₂, Li₂ZrF₆, Sn₂ZrF₈, SnZrF₆ and Sn₄ZrF₁₂.

29. Process according to claim 24, wherein at least one of R1, R2, R3 and R4 of the cation (b2) is
(i) a linear or branched aliphatic radical C₁-C₁₂ optionally provided with
(ia) substituents located on the terminal or intermediate groups of the chain, selected from the group consisting of oxydryl, aminic, iminic, amidic, carboxylic groups, organic radicals, and substituted organic radicals, and/or
(ib) bivalent groups —NR5-, —O— or —CONH— inserted in the aliphatic chain, and/or
(ic) 1-4 double and/or triple bonds in the chain, or
(ii) a cycloaliphatic or aromatic radical C₄-C₆ optionally provided with
(iia) substituents located on the groups of the aliphatic or aromatic cycle, selected from the group consisting of oxydryl, aminic, amidic, carboxylic groups, organic radicals, and substituted organic radicals, and/or
(iib) bivalent groups —NR5-, —O— or —CONH— inserted in the aliphatic cycle, and/or
(iic) 1-2 double bonds, or
(iii) R1 and R2 together are a bivalent radical C₄-C₆ constituting an aliphatic or aromatic cycle comprising nitrogen, optionally provided with
(iiia) substituents located on the groups of the aliphatic or aromatic cycle, selected from the group consisting of oxydryl, aminic, amidic, carboxylic groups, organic radicals, and substituted organic radicals, and/or
(iiib) bivalent groups —NR5-, —O— inserted in the aliphatic or aromatic cycle, and/or
(iiic) 1-2 double bonds,
wherein R5 is an organic radical or is H.

30. Process according to claim 29, wherein the linear organic radicals (ia) and/or (ib) are selected from the group consisting of
—CH2CH2NHCH2CH2NH2,
—CH2CH2NHCH2CH2NHCH2CH2NH2,
—CH2CH2NHCH2CH2NHCH2CH2NHCH2CH2NH2, and
—CH2CH2CH2NHCH2CH2NHCH2CH2CH2NH2.

31. Process according to claim 29, wherein the cation (b2) is selected from group consisting of hydroxylammonium, methylammonium, ethylammonium, propylammonium, dimethylammonium, diethylammonium, dipropylammonium, trimethylammonium, triethylammonium, tripropylammonium, 2-ethanolammonium, diethanolammonium, triethanolammonium, isopropylammonium, diisopropylammonium, triisopropylammonium, n-butylammonium, isobutylammonium, sec-butylammonium, tert-butylammonium, cyclohexylammonium, benzylammonium, alfa-phenylethylammonium, beta-phenylethylammonium, diphenylammonium, triphenylammonium, phenylammonium, dibenzylammonium, aminoethylenammonium, aminopropylenammonium, aminohexamethylenammonium, piperazonium, methylpiperazonium, ethylpiperazonium, 2-aminoethylpiperazonium, morpholinonium, pyridinium, bis-2-aminoethylammonium, bis-2-aminopropylammonium, propanolammonium, di-propanolammonium, tris-propanolammonium, hydroxyl-ethyl-piperazonium, hydroxyl-propyl-piperazonium, di-butylammonium, di-cyclohexylammonium, N,N′-dimethylpiperazonium, N-methylmorpholinonium, piperidonium, N-methylpiperidonium, N,N′-di-(2-hydroxyethyl)piperazonium, N-methyl-hydroxyethylpiperazonium, N,N′-di-(2-hydroxypropyl)piperazonium, N-methyl-2-hydroxypropylpiperazonium, N,N′-1,2-ethandiilbis[N-(carboxymethyl)]-glycinonium, N,N-bis[2-[bis(carboxymethyl)amino]ethyl]-glycinonium, N,N-bis(carboxymethyl)-glycinonium, N-(carboxymethyl)-glycinonium, N-[2-[bis(carboxymethyl)amino]ethyl]-N-(2-hydroxyethyl)-glycinonium, α,α′-(1,2-ethandiildiimino)bis[2-hydroxy]benzenacetic-onium acid, α,α′-(1,2-ethandiildiimino)bis[2-hydroxy]-4-methylbenzenacetic-onium acid, and α,α′-(1,2-ethandiildiimino)bis[2-hydroxy]-5-methylbenzenacetic-onium acid.

32. Process according to claim 29, wherein the cation (b2) is a derivative of a compound selected from the group consisting of arginine, aspartic acid, glutamic acid, glycine, leucine, lysine, proline, tyrosine, and a mixture of at least one of the compounds arginine, aspartic acid, glutamic acid, glycine, leucine, lysine, proline, and tyrosine.

33. Process according to claim 24, wherein the liquid coloring composition is a coloring suspension in which at least 20 weight percent of the total amount of salts and/or complexes is dissolved.

34. Process according to claim 24, wherein the liquid coloring composition is an ink in which the salts and/or complexes are totally solubilised and the cations (b) are independently selected among (b1) and (b2).

35. Process according to claim 34, wherein the liquid coloring composition further comprises a solvent selected from the group consisting of water, water-miscible solvents and mixtures of water and water-miscible solvents.

36. Process according to claim 34, wherein the liquid coloring composition further comprises a water-immiscible solvent or a mixture between different water-immiscible solvents.

37. Process according to claim 33, wherein the liquid coloring composition comprises salts and/or complexes formed by one or more fluorometallate anion (a) and cations (b3), and the liquid is selected from the group consisting of water, water-miscible liquids, and mixtures of water and water-miscible liquids.

38. Process according to claim 24, further comprising
preparing a raw or partially fired ceramic article to be decorated,
treating the ceramic article with the liquid coloring composition on the surface of said ceramic article, and
firing the ceramic article obtained from the steps of preparing and treating at a temperature of at least 940° C.

39. Process according to claim 38, wherein firing is carried out using the same firing parameters usable for firing the same untreated ceramic manufactured article and a firing temperature which ranges from +20° C. to −20° C. with respect to the firing temperature usable for firing the same untreated ceramic article.

40. Process according to claim 38, wherein the treating is with the liquid coloring composition in the form of an ink in which the salts and/or complexes are totally solubilised and the cations (b) are independently selected among (b1) and (b2), further wherein the ink is applied using an ink-jet printing device.

41. Process according to claim 38, wherein treating is carried out in two steps by firstly uniformly treating the ceramic article with the liquid coloring composition and subsequently by applying conventional coloring solution.

42. Process according to claim 38, wherein treating is carried out in two steps by firstly uniformly treating the ceramic manufactured article with the liquid coloring composition and subsequently by applying inks using one or more ink-jet devices.

43. Process according to claim 38, further comprising one or more of the following steps:
a pre-treatment, to be carried out between said steps of preparing a raw or partially fired ceramic article to be decorated and treating the ceramic article with the liquid coloring composition, of said raw or partially fired ceramic article to be decorated with water, with aqueous solutions of mono- or poly-carboxylic acids, or with aqueous solutions of mono- or poly-carboxylic acids partially or completely salified with ammonium, amines, alkaline metals and/or alkaline-earth metals;
a post-treatment, to be carried out between said steps of treating the ceramic article with the liquid coloring composition and firing the ceramic article, of said ceramic article with water, with aqueous solutions of mono- or poly-carboxylic acids, or with aqueous solutions of mono- or poly-carboxylic acids partially or completely salified with ammonium, amines, alkaline metals and/or alkaline-earth metals, or with aqueous solutions of halogenates; and
a drying and/or balancing post-treatment to be carried out between said steps of treating the ceramic article with the liquid coloring composition and firing the ceramic article.

44. Ceramic article obtainable from the process as described in claim 24, the surface of which is totally or partially white colored or decolored.

45. Ceramic article according to claim 44, wherein said article is made of porcelain stoneware and the surface of said article is totally or partially abraded after firing.

46. Liquid coloring composition applicable before firing on ceramic articles to obtain after firing the decoration of said ceramic articles, said composition comprising salts and/or complexes formed by:
(a) one or more fluorometallate anions with the formula [MxFy]^{z-} where x, y and z are numeric coefficients and where x ranges from 1 to 7, y ranges from 2 to 31, and z ranges from 1 to 7, in which F is fluorine and in which M is selected from the group consisting of Zr, Ti, Sn and Al,
(b) one or more cations independently selected from the group consisting of
(b1) Al, Sb, Ce, Zn, Ca, Li, Na, K, Mg, Sr, Ba, Hf, Sc, Y, Lu, Ga, As, Se and Te,
(b2) cations having the general formula: 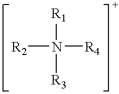
where
R1 is an organic radical, a substituted organic radical, or a hydroxyl, and
R2, R3 and R4 are, independently from each other, equal to H, an organic radical, or a substituted organic radical.

47. Liquid coloring composition according to claim 46, wherein M is Zr.

48. Liquid coloring composition according to claim 47, wherein the Zr:F ratio ranges from 1:4 to 1:12.

49. Liquid coloring composition according to claim 47, wherein said composition comprises at least one compound selected from the group consisting of K₂Zn(ZrF₆)₂, Zn(ZrF₆)5H₂O, Na₄(ZrF₈), Ba(ZrF₄), Mg(ZrF₆), Mg(ZrF₆)6H₂O, Zn₂(ZrF₈)12H₂O, BaNa(ZrF₇), Ba₂(Zr₂F₁₂), Zn(ZrF₆)6H₂O, Zn(ZrF₆), Ba₃(ZrF₁₀), Na₅(Zr₂F₁₃), Ba(ZrF₆), Na₇Zr₆F₃₁, BaZr₂F₁₀, BaNaZr₂F₁₁, KSnZrF₇, YZrF₇, YZr₃F₁₅, BaZr₃F₁₄, BaZr₂F₁₀, NaZrF₅, CeZr₂F₁₁, LuZr₃F₁₅, Ba₂Zr₃F₁₆, Ba₃Zr₂F₁₄, Na₃Zr₂F₁₁, Na₂ZrF₆, KNaZrF₆, Al₂(ZrF₆)₃, Na₃ZrF₇, Zn₆ZrF₆x6H₂O, K₃Na₂(ZrF₅)₅, (K₂ZnZrF₆)6H₂O, NaZnZr₂F₁₁, (ZnZr₂F₁₀)7H₂O, CeKZr₂F₁₂, BaLiZr₂F₁₁, Na₃Zr₄F₁₉, Ba₂Zr₈, (ZnZr₂F₁₀)H₂O, LuKZr₂F₁₂, BaHfNaZrF₁₁, LuZrF₇, (NaZrF₅)H₂O, Na₇Zr₆F₃₁, LiNaZr₄F₁₈, K₃Na₃(ZrF₇)₂ and Li₂ZrF₆.

50. Liquid coloring composition according to claim 46, wherein component (b2) is a cation in which at least one among R1, R2, R3 and R4 is
(i) a linear or branched aliphatic radical C₁-C₁₂ optionally provided with
(ia) substituents located on the terminal or intermediate groups of the chain, selected from the group consisting of oxydryl, aminic, iminic, amidic, carboxylic groups, organic radicals, and substituted organic radicals, and/or
(ib) bivalent groups —NR5-, —O— or —CONH— inserted in the aliphatic chain, and/or
(ic) 1-4 double and/or triple bonds in the chain, or
(iii) a cycloaliphatic or aromatic radical C₄-C₆ optionally provided with
(iia) substituents located on the groups of the aliphatic or aromatic cycle, selected from the group consisting of oxydryl, aminic, amidic, carboxylic groups, organic radicals, and substituted organic radicals, and/or
(iib) bivalent groups —NR5-, —O— or —CONH— inserted in the aliphatic cycle, and/or
(iic) 1-2 double bonds, or
(iii) R1 and R2 together are a bivalent radical C₄-C₆ constituting an aliphatic or aromatic cycle comprising nitrogen, optionally provided with
(iiia) substituents located on the groups of the aliphatic or aromatic cycle, selected from the group consisting of oxydryl, aminic, amidic, carboxylic groups, organic radicals, and substituted organic radicals, and/or
(iiib) bivalent groups —NR5-, —O— inserted in the aliphatic or aromatic cycle, and/or
(iiic) 1-2 double bonds,
wherein R5 is an organic radical or is H.

51. Liquid coloring composition according to claim 50, wherein the linear organic radicals (ia) and/or (ib) are selected from the group consisting of
—CH2CH2NHCH2CH2NH2,
—CH2CH2NHCH2CH2NHCH2CH2NH2,
—CH2CH2NHCH2CH2NHCH2CH2NHCH2CH2NH2, and
—CH2CH2CH2NHCH2CH2NHCH2CH2CH2NH2.

52. Liquid coloring composition according to claim 50, wherein (b2) is selected from the group consisting of hydroxylammonium, methylammonium, ethylammonium, propylammonium, dimethylammonium, diethylammonium, dipropylammonium, trimethylammonium, triethylammonium, tripropylammonium, 2-ethanolammonium, diethanolammonium, triethanolammonium, isopropylammonium, diisopropylammonium, triisopropylammonium, n-butylammonium, isobutylammonium, sec-butylammonium, tert-butylammonium, cyclohexylammonium, benzylammonium, alfa-phenylethylammonium, beta-phenylethylammonium, diphenylammonium, triphenylammonium, phenylammonium, dibenzylammonium, aminoethylenammonium, aminopropylenammonium, aminohexamethylenammonium, piperazonium, methylpiperazonium, ethylpiperazonium, 2-aminoethylpiperazonium, morpholinonium, pyridinium, bis-2-aminoethylammonium, bis-2-aminopropylammonium, propanolammonium, di-propanolammonium, tris-propanolammonium, hydroxyl-ethyl-piperazonium, hydroxyl-propyl-piperazonium, di-butylammonium, di-cyclohexylammonium, N,N′-dimethylpiperazonium, N-methylmorpholinonium, piperidonium, N-methylpiperidonium, N,N′-di-(2-hydroxyethyl)piperazonium, N-methyl hydroxyethylpiperazonium, N,N′-di-(2-hydroxypropyl)piperazonium, N-methyl-2-hydroxypropylpiperazonium, N,N′-1,2-ethandiilbis[N-(carboxymethyl)]-glycinonium, N,N-bis[2-[bis(carboxymethyl)amino]ethyl]-glycinonium, N,N-bis(carboxymethyl)-glycinonium, N-(carboxymethyl)-glycinonium, N-[2-[bis(carboxymethyl)amino]ethyl]-N-(2-hydroxyethyl)-glycinonium, α,α′-(1,2-ethandiildiimino)bis[2-hydroxy]benzenacetic-onium acid, α,α′-(1,2-ethandiildiimino)bis[2-hydroxy]-4-methylbenzenacetic-onium acid, and α,α′-(1,2-ethandiildiimino)bis[2-hydroxy]-5-methylbenzenacetic-onium acid.

53. Liquid coloring composition according to claim 50, wherein the cation (b2) is a derivative of a compounds selected from the group consisting of arginine, aspartic acid, glutamic acid, glycine, leucine, lysine, proline, tyrosine, and a mixture of at least one of the compounds arginine, aspartic acid, glutamic acid, glycine, leucine, lysine, proline, and tyrosine.

54. Liquid coloring composition according to claim 46, wherein said composition is a coloring suspension in which at least 20 weight percent of the total amount of salts and/or complexes is dissolved.

55. Liquid coloring composition according to claim 46, wherein said composition is an ink in which the salts and/or complexes are totally solubilised and the cations (b) are independently selected among (b1) and (b2).

56. Ink according to claim 55, wherein said ink further comprises a solvent selected from the group consisting of water, water-miscible solvents and mixtures of water and water-miscible solvents.

57. Ink according to claim 55, wherein said ink further comprises a water-immiscible solvent or a mixture between different water-immiscible solvents.
